(19) United States
(12) Patent Application Publication
(10) Pub. No.: US 2026/0276866 A1
(43) Pub. Date: Sep. 17, 2026

(54) POLYMER OPTICAL FIBER

(71) Applicant: ZEUS COMPANY INC., Orangeburg, SC (US)

(72) Inventors: Zeth Eberling, Lexington, SC (US); Josh Fogle, Columbia, SC (US); Jason Fant, Lexington, SC (US)

(21) Appl. No.: 19/670,652

(22) Filed: May 7, 2026

Related U.S. Application Data
(63) Continuation of application No. 18/229,962, filed on Aug. 3, 2023.
(60) Provisional application No. 63/394,695, filed on Aug. 3, 2022.

(51) Int. Cl. G02B 1/04; B29D 11/00

(52) U.S. Cl. CPC G02B 1/046; B29D 11/00711; G02B 1/048

(57) ABSTRACT

Polymer optical fibers (POFs) including a polyamide core are described herein. The polyamide cores generally include one or more nylon polymers and are microcrystalline. The described POFs can have an operating temperature exceeding 150° C. and a calculated numerical aperture of 0.6 or greater.

### CROSS-REFERENCE TO RELATED APPLICATIONS

The present application is a continuation of U.S. patent application Ser. No. 18/229,962, filed Aug. 3, 2023, which claims the benefit of U.S. Provisional Application No. 63/394,695, filed Aug. 3, 2022, the disclosures of which are incorporated herein by reference in its entirety.

### FIELD OF THE INVENTION

The present application is directed to polymer optical fibers and methods for making such polymer optical fibers, which find application in a variety of fields.

### BACKGROUND

Optical fibers are fibers useful for transmitting lights from one end of the fiber to the other end of the fiber; they are applicable, for example, in optical communication, permitting transmission over longer distances and at higher bandwidths than electrical cables. Optical fibers are also used for illumination and imaging, as well as in the context of optical sensors and fiber lasers.

The composition of such optical fibers can vary. Oftentimes, optical fibers comprise glass (silica) and/or plastic materials. In particular, some optical fibers comprise a polymer core and a polymer cladding. For example, EP0472384A2 describes polymer optical fibers with a variety of monomers that can be used to manufacture the polymer core of the fiber. JPH08304639A discloses a polymer optical fiber which has a matrix of a non-crystalline fluoropolymer, having substantially no C—H bond. JP3059147B2 provides optical fibers via the polymerization of a halogenated polyamideimide, used for optical communication (referencing the necessity of avoiding polymers with C—H bonds for light conduits since these bonds absorb light intensely in the near infrared region). U.S. Pat. No. 7,058,271 discloses optical fibers comprising cores made from a variety of polymers including an acrylic polymer, a polystyrene, a polynorbornene, a polycarbonate, a polyimide and a polyester. One exemplary polymer optical fiber is a Mitsubishi Eska SK-20 Fiber with a poly(methylmethacrylate) (“PMMA”) core and a fluorinated ethylene propylene (“FEP”) cladding, which has a 70° C. maximum operating temperature (MOT). Another example of an optical fiber is a Hitachi HPOF Fiber with a silicone core and an FEP cladding, which has a 150° C. MOT.

Optical fibers comprising polyamide coatings are known. See for example, Sapozhnikov et al., “Heat-Resistant Polymeric coatings of Optical Fibers”, Polymer Science, Series C, 62, 165-171, 2020. Trogamid CX polyamide resin is currently used as an optical material for the manufacture of lenses, that is, for applications with relatively short optical length where attenuation is not an issue. Polyamide, however, has not heretofore been used within the core of an optical fiber; cores conventionally comprise silica or PMMA, e.g., as included in the Mitsubishi and Hitachi optical fibers referenced above.

There is a continuing need for a polymer optical fiber (POF) that can operate in harsh chemical environments (e.g., during sterilization procedures) at elevated temperatures, including, but not limited to, the temperature required to deposit a cladding layer thereon.

### SUMMARY

The disclosure provides optical fibers, methods of making such optical fibers, and methods of using optical fibers. According to various embodiments, the disclosure provides an optical fiber that comprises, or is manufactured using, materials that can operate at a temperature range of 150° to 170° C., with excellent chemical resistance, particularly to hydrocarbons, alcohols, phenols and lipids. Moreover, the optical fibers provided herein according to various embodiments can advantageously maintain large numerical aperture (NA) at elevated temperatures and in harsh chemical environments. In some embodiments, TROGAMID® CX polyamide resin is used as a core material for optical fibers through careful processing of the material.

The disclosure includes, without limitations, the following embodiments.
Embodiment 1: A polymer optical fiber (POF) comprising: a core comprising one or more polyamides; and a cladding comprising one or more fluoropolymers, wherein the POF has an operating temperature exceeding 150° C. and a calculated numerical aperture (NA) of 0.6 or greater.
Embodiment 2: The POF of Embodiment 1, wherein the one or more polyamides comprise a microcrystalline polyamide.
Embodiment 3: The POF of Embodiment 1, wherein the one or more polyamides consist essentially of a microcrystalline polyamide.
Embodiment 4: The POF of any of Embodiments 1-3, wherein the one or more polyamides comprise a transparent polyamide.
Embodiment 5: The POF of Embodiment 4, wherein the one or more polyamides consist essentially of a transparent polyamide.
Embodiment 6: The POF of any of Embodiments 1-5, wherein the one or more polyamides comprise a nylon.
Embodiment 7: The POF of Embodiment 6, wherein the one or more polyamides consist essentially of a nylon.
Embodiment 8: The POF of any of Embodiments 1-7, wherein the one or more polyamides comprise a polymer comprising cycloaliphatic diamine and 1,12-dodecanedioic acid monomers.
Embodiment 9: The POF of Embodiment 8, wherein the one or more polyamides consist essentially of a polymer comprising cycloaliphatic diamine and 1,12-dodecanedioic acid monomers.
Embodiment 10: The POF of any of Embodiments 1-9, wherein the one or more polyamides comprise TROGAMID® CX polyamide.
Embodiment 11: The POF of Embodiment 10, wherein the one or more polyamides consist essentially of TROGAMID® CX polyamide.
Embodiment 12: The POF of any of Embodiments 1-11, wherein the core consists essentially of the one or more polyamides.
Embodiment 13: The POF of any of Embodiments 1-11, wherein the core further comprises one or more additives.
Embodiment 14: The POF of Embodiment 13, wherein the one or more additives comprise a refractive index-modifying agent.
Embodiment 15: The POF of any of Embodiments 1-14, wherein the cladding comprises one or more fluoropolymers selected from the group consisting of poly(tetrafluoroethylene-co-hexafluoropropylene) (FEP), EFEP (a terpolymer comprising ethylene, tetrafluoroethylene (TFE), and hexafluoropropylene (HFP) monomers), polytetrafluoroethylene-alt-ethylene (ETFE), copolymers of tetrafluoroethylene and perfluoromethyl vinyl ether (MFA), copolymers of perfluoro(alkyl vinyl ether) (PFE), and copolymers, combinations, and derivatives thereof.
Embodiment 16: The POF of any of Embodiments 1-15, wherein the cladding consists essentially of the fluoropolymeric material.
Embodiment 17: The POF of any of Embodiments 1-16, wherein the cladding further comprises one or more additives.
Embodiment 18: The POF of any of Embodiments 1-17, consisting essentially of the core and the cladding.
Embodiment 19: A method of making the POF of any of Embodiments 1-18, comprising extruding the cladding over the core.
Embodiment 20: A method of making the POF of any of Embodiments 1-18, comprising applying the cladding over the core and heat shrinking the cladding onto the core.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### DETAILED DESCRIPTION

The present invention will now be described more fully hereinafter with reference to the accompanying figures, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present disclosure provides polymer optical fibers (POFs) with a core and cladding structure, wherein the core comprises a polyamide. According to the present disclosure, the inventors have found that materials comprising certain polyamides can be uniquely selected for use in the core of a POF in combination with various cladding materials to provide desired properties to the POF, as will be described further herein below.

As referenced herein above, the core of the disclosed POFs uniquely comprises a polyamide. The term “polyamide” generally encompasses polymers with repeating units linked by amide (—CO—NH) units. A broad range of polyamides are known, including, but not limited to, various nylons (aliphatic polyamides) and aramids (aromatic polyamides). It is generally known that the properties of such polyamides are widely variable, depending, e.g., on the distance between adjacent amide units, the composition between adjacent amide units, and the like. Polyamides very in both composition and corresponding physical properties and the present disclosure describes, in part, the identification and use of suitable polyamides for application in the context of POF cores.

In some embodiments, suitable polyamides are crystallizable polyamides, e.g., crystallizable nylons (i.e., aliphatic polyamides). Advantageously, in preferred embodiments, the crystallites of the crystallizable polyamide are so small that they do not scatter visible light. Accordingly, the crystallizable polyamides in such embodiments appear transparent to the human eye (i.e., the polyamide exhibits “microcrystallinity”). Although not intending to be limited by theory, it is believed that the microcrystalline structure of certain polyamides lends various beneficial properties to the resulting POF core, e.g., the types of properties which may arise from crystallinity including, but not limited to, stress-cracking resistance and limited to no visual clouding of the material. It is noted that in preferred embodiments, the crystalline proportion is low enough so as to not negatively impact the shrinkage behavior of the core (i.e., isotopic shrinkage behavior generally observed in amorphous materials is advantageously substantially retained in the crystallizable polyamide).

Suitable polyamides for the purposes described herein generally exhibit good optical properties. For example, in some embodiments, they may exhibit high clarity and high transmission. In some embodiments, they exhibit high UV resistance.

In some embodiments, suitable polyamides are transparent or substantially transparent. In some embodiments, suitable polyamides can be characterized as “permanently transparent.” By “permanently transparent” is meant that, in some embodiments, the material maintains its transparency (e.g., based on visual observation) over an extended period of time, e.g., two months or more, six months or more, a year or more, two years or more, three years or more, four years or more, five years or more, ten years or more, 20 years or more, or 50 years or more. In some embodiments, “permanently transparent” indicates that the material maintains its transparency (e.g., based on visual observation) under a wide range of conditions (e.g., temperatures up to and exceeding 200° C., 300° C., 400° C., 500° C., or 600° C. In some embodiments, the references herein to “permanently transparent” encompass (at least) visual transparency in the conditions and for the lifetime for which the material is intended. For example, a core as provided herein can be described as “permanently transparent” for use under the conditions in which the optical fiber is to be employed (which may include elevated temperature, elevated pressure, exposure to caustic chemicals, or the like).

TROGAMID® CX is an example of a crystallizable and permanently transparent polyamide. TROGAMID® CX comprises cycloaliphatic diamine and dodecanoic acid monomeric units. This material, described in further detail, e.g., at trogamid.com (last accessed Jul. 24, 2023),which is incorporated herein by reference in its entirety, comprises crystallites so small that they do not scatter visible light thereby achieving high clarity and permanent transparency, with high transmission (e.g., 92%), outstanding chemical and stress-cracking resistance, high dynamic strength (number of load cycles), very high toughness, even at low temperatures, abrasion resistance and scratch resistance, and/or very low isotropic shrinkage.

Generally, unlike other polymers commonly used for POFs, polyamides show strong absorption peaks towards the NIR region of the spectrum due to the N—H bond stretch (see Table 1 below from: H. A. Mahdi, J. Pure and Appl. Sci., 24, 1, 2011, incorporated herein by reference). Surprisingly, the polyamides provided herein, when processed into the form of a POF (as the core material), transmit visible light without significant absorption near the red end of the spectrum. In fact, absorbance at the infrared end of the spectrum for such materials (e.g., TROGAMID® polyamide) shows less activity beyond 3000 cm⁻¹ with a relatively weaker N—H stretching band when compared to other polyamides such as Nylon 6, Nylon 6,6, Nylon 4,6, Nylon 11, Nylon 6,11 and Nylon 6,12. See M. Enlow, J. L. Kennedy, A. A. Nieuwland, J. E. Hendrix, S. L. Morgan, Applied Spectroscopy, 59, 986-992, 2005, which is incorporated herein by reference in its entirety. In this way, the properties of TROGAMID® render it more closely aligned with non-amine containing materials currently used as cores for POF such as PMMA. See G. Vijayakumari, N. Selvakumar, K. Jeyasubramanian, R. Mala, Physics Procedia, 49, 67-78, 2013, which is incorporated herein by reference in its entirety.

TABLE 1
Assignment of FTIR spectrum of neat nylon 6,6

| Wave number | | |
|---|---|---|
| (cm⁻¹) | Absorbance | Assignment |
| 3410 | 0.34 | N—H stretching I |
| 3306 | 0.38 | N—H stretching II |
| 3082 | 0.18 | C—H stretching (asym) |
| 2932 | 0.28 | CH₂ stretching (asym) |
| 2862 | 0.25 | CH₂ stretching (sym) |
| 1639 | 0.53 | Amide I stretching |
| 1539 | 0.46 | Amide II stretching/CH₂ (asy)(mdel) |
| 1469 | 0.31 | N—H deformation/CH₂ scissoring |
| 1269 | 0.34 | Amide III stretching |
| 1200 | 0.29 | CCH bending (sym)/CH₂ twisting |
| 934 | 0.17 | C—C stretching |
| 691 | 0.20 | C—C bending |
| 579 | 0.18 | C—C deformation |

The core comprising a polyamide material as described herein may comprise, consist essentially of, or consist of the selected polyamide(s). In some embodiments, the core may contain small amounts of stabilizers or other components (e.g., which were included in the polyamide resin obtained and processed to form the disclosed cores). In other embodiments, the core may contain one or more additional components (additives) intentionally added thereto, e.g., including, but not limited to, a refractive index-raising agent.

The cladding material of the POFs provided herein can vary and can be any conventional cladding material. Although not limited thereto, the cladding typically comprises a material with a lower refractive index than the material of the core. In some embodiments, the cladding material is a fluoropolymer material. In some embodiments, the cladding comprises poly(tetrafluoroethylene-co-hexafluoropropylene) (FEP), EFEP (a terpolymer comprising ethylene, tetrafluoroethylene (TFE), and hexafluoropropylene (HFP) monomers), polytetrafluoroethylene-alt-ethylene (ETFE), copolymers of tetrafluoroethylene and perfluoromethyl vinyl ether (MFA), copolymers of perfluoro(alkyl vinyl ether) (PFE), and copolymers, combinations, and derivatives thereof. In some embodiments, the cladding material is applied as a heat shrink material (e.g., FEP) and heat shrunk onto the core.

In some embodiments, the cladding consists essentially of the cladding material (e.g., fluoropolymer). In other ingredients, the cladding can further comprise one or more additives. Exemplary additives include, but are not limited to, radio opaque fillers (e.g., barium sulfate and/or bismuth trioxide).

Advantageously, the core and cladding layers of the disclosed POFs do not exhibit substantial delamination as determined, e.g., via a peel test as known in the art.

In some embodiments, the POFs provided herein can comprise further components. For example, one or more jackets and/or buffer layers as generally known in the art can overly the cladding, e.g., to protect the core and cladding. The POFs provided herein can, in some embodiments, have reasonably high operating temperatures (even in the absence of an overlying jacket and/or buffer layer). In some embodiments, the POFs can have an operating temperature exceeding 150° C., exceeding 155° C., or exceeding 160° C., e.g., such as about 150° C. to about 180° C. or about 150° C. to about 170° C. It is noted that, in some embodiments, the POFs provided herein can exhibit even higher operating temperatures, e.g., when coated with a suitable jacket and/or buffer layer.

The POFs provided herein can exhibit good physical properties/technical attributes, e.g., including but not limited to, numerical aperture (“NA”) and critical angle for total internal reflection (“θ_{c}”) rendering the disclosed POFs good for various optical fiber applications. In some embodiments, the POFs herein exhibit calculated NA values about 0.4 or greater, about 0.5 or greater, or about 0.6 or greater. NA can be determined by angle of total internal reflection, calculated using Snells law. FEP (ri 1.34) Trogamid CX(ri 1.51)−Critical angle 62.55° At θ30° i limit 70.66°, θmax 44.11° NA=0.696.

As one, non-limiting demonstration of the types of values exhibited by the disclosed POFs, a fiber comprising a microcrystalline polyamide (e.g., TROGAMID® CX) and an EFEP cladding is provided. Numerical aperture (“NA”) is defined as the sine of the largest angle an incident ray can have for total internal reflectance in the core (as shown below). A higher core index with respect to the cladding leads to a larger NA value. The theoretical NA is calculated based on the formula:

$$N A = \sqrt{{n}_{core}^{2} - {n}_{cladding}^{2}}$$

The refractive index of EFEP is around 1.40 and the refractive index of TROGAMID® is around 1.52, which gives a theoretical NA for the demonstrated POF of around 0.60. In some embodiments, a POF is provided which has a calculated numerical aperture of 0.6 or greater.

The critical angle for total internal reflection (θ_{c}) is given by the formula:

$${θ}_{c} = arcsin \frac{{n}_{cladding}}{{n}_{core}}$$

For the representative POF comprising EFEP and TROGAMID®, the theoretical value for θ_{c} is thus around 67°. These results will depend on the exact resin grades used, as well as on the processing conditions.

The optical fibers provided herein can be prepared according to conventional methods. In some embodiments, POFs are drawn from fiber preforms comprising the desired materials. In some embodiments, POFs are prepared via extrusion of the selected core and cladding materials (independently or simultaneously). In some embodiments, POFs are prepared by coating a core with a heatshrink cladding material and heating the heatshrink cladding material.

The sizes and core:cladding ratios of the POFs provided herein can vary widely and the principles outlined herein are applicable across a broad range. In some embodiments, the core can have a diameter up to about 1 mm. In some embodiments, the POFs provided herein thus are considered to be “large core” POFs. In some embodiments, the core has a diameter of about 100 to about 2000 microns and the cladding thickness also ranges from about 100 to about 2000 microns.

The POFs provide herein can be used for various applications, e.g., any of the applications for which POFs are conventionally employed. For example, they can be used for optical data transmission (e.g., in industrial environments, the automotive industry, the aircraft industry, consumer markets, digital home appliance interfaces, and home and car networks) and for illumination purposes.

### Examples

The various embodiments of the invention can be more fully demonstrated through the following non-limiting examples.

Example 1.TROGAMID® CX polyamide resin was dried to a moisture level less than 0.1% and was extruded into a monofilament of 0.022 inch diameter using a single screw extruder equipped with a 0.708 inch mixing screw with a 24:1 length-to-diameter ratio (L/D). The EFEP cladding was then extruded over the TROGAMID® monofilament core by feeding the core through the extrusion head and die/mandrel setup. The target wall thickness of the EFEP cladding was 0.005 inches. The resulting optical fiber displayed good adhesion between the core and cladding and good clarity.

Example 2. TROGAMID® CX polyamide resin was dried to a moisture level less than 0.1%. A single screw extruder equipped with a 0.75 inch mixing screw and 24:1 L/D was used to extrude TROGAMID® as the inner layer. A single screw extruder equipped with a 0.75 inch mixing screw and 24:1 L/D was used to extrude EFEP as the outer layer. The inner and outer layers were extruded simultaneously utilizing a coextrusion crosshead to produce a 0.018 inch diameter solid inner layer with a 0.001 inch outer layer thickness.

Example 3. The TROGAMID® monofilament core from Example 1 and FEP heatshrink were utilized to make discrete optical fiber lengths. FEP heatshrink tubing was manually fed over a length of TROGAMID® core. The FEP heatshrink was then recovered using a heat gun to fit snugly around the core. The resulting optical fiber displayed good adhesion between the core/cladding and good clarity.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A polymer optical fiber (POF) comprising:
a core comprising one or more polyamides wherein the core has a diameter of 100 to 2000 microns; and
a cladding comprising one or more fluoropolymers,
wherein the POF has an operating temperature exceeding 150° C. and a calculated numerical aperture (NA) of 0.6 or greater.

2. The POF of claim 1, wherein the one or more polyamides comprise a transparent polyamide.

3. The POF of claim 1, wherein the one or more polyamides consist essentially of a transparent polyamide.

4. The POF of claim 1, wherein the one or more polyamides comprise a nylon.

5. The POF of claim 1, wherein the one or more polyamides consist essentially of a nylon.

6. The POF of claim 1, wherein the one or more polyamides comprise an aramid

7. The POF of claim 1, wherein the one or more polyamides comprise a polymer comprising cycloaliphatic diamine and 1,12-dodecanedioic acid monomers.

8. The POF of claim 1, wherein the one or more microcrystalline polyamides consist essentially of a polymer comprising cycloaliphatic diamine and 1,12-dodecanedioic acid monomers.

9. The POF of claim 1, wherein the one or more polyamides comprise TROGAMID® CX polyamide.

10. The POF of claim 1, wherein the one or more polyamides consist essentially of TROGAMID® CX polyamide.

11. The POF of claim 1, wherein the core consists essentially of the one or more polyamides.

12. The POF of claim 1, wherein the core further comprises one or more additives.

13. The POF of claim 12, wherein the one or more additives comprise a refractive index-modifying agent.

14. The POF of claim 1, wherein the one or more fluoropolymers are selected from the group consisting of poly(tetrafluoroethylene-co-hexafluoropropylene) (FEP), EFEP (a terpolymer comprising ethylene, tetrafluoroethylene (TFE), and hexafluoropropylene (HFP) monomers), polytetrafluoroethylene-alt-ethylene (ETFE), copolymers of tetrafluoroethylene and perfluoromethyl vinyl ether (MFA), copolymers of perfluoro(alkyl vinyl ether) (PFE), and copolymers, combinations, and derivatives thereof.

15. The POF of claim 1, wherein the cladding consists essentially of the fluoropolymeric material.

16. The POF of claim 1, wherein the cladding further comprises one or more additives.

17. The POF of claim 1, consisting essentially of the core and the cladding.

18. The POF of claim 1, wherein the cladding has a thickness of 100 to 2000 microns.

19. A method of making the POF of claim 1, comprising extruding the cladding over the core.

20. A method of making the POF of claim 1, comprising applying the cladding over the core and heat shrinking the cladding onto the core.
